(19) United States
(12) Patent Application Publication
(10) Pub. No.: US 2009/0017809 A1
(43) Pub. Date: Jan. 15, 2009

(54) SUPPORT SERVICE ARCHITECTURE FOR A MOBILE VIRTUAL NETWORK OPERATOR

(76) Inventors: Rashesh J. Jethi, Fremont, CA (US); Venkatesan Raghavan, Oakland, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/970,883

(22) Filed: Jan. 8, 2008

Related U.S. Application Data
(60) Provisional application No. 60/879,491, filed on Jan. 8, 2007.

(51) Int. Cl. H04M 3/00

(52) U.S. Cl. 455/418

(57) ABSTRACT

A system and method for implementing content or services customized for a branded company via a choice of data platforms of the brand company's choosing and independent of the wireless data infrastructure offered by the wireless network provider are disclosed. A control module receives a request for content or services from a branded company through an input interface, such as a wireless network interface, a third-party system interface or a brand system interface. The control module is adapted to communicate with a data platform services adapter which associates an external system, such as a third-party system or a data platform, with the branded company providing the request. The data platform services adapter transmits the received request to the associated external system using an output interface which adapted to communicate with the control module.

### CROSS REFERENCE TO RELATED APPLICATIONS

This application claims priority under 35 U.S.C. § 119(e) from U.S. Provisional Application No. 60/879,491, filed Jan. 8, 2007, which is incorporated by reference herein in its entirety.

### BACKGROUND

1. Field of Art

The present generally relates to the field of data services for wireless networks, and more specifically to enabling a Mobile Virtual Network Operator (MVNO) to create a customized wireless offering.

2. Description of the Related Art

A company can leverage the strength of its brand by offering wireless services. Offering wireless services provides a branded company with an additional revenue stream, an additional channel for customer communication and deeper customer relationships and/or enhanced customer loyalty initiatives. However, companies face many difficulties in implementing wireless services. For example, to implement a wireless service, technology is required for customer management, application management, subscriber interfaces and/or billing management. Additionally, third-party interfaces are necessary to outsource additional services such as customer care, order fulfillment and product distribution. Further, wireless service implementation requires access to a cellular communication network and systems for managing voice and data transport across the communication network, entry of raw call detail record (CDR) feeds into a billing system and other functions.

Because of these difficulties, many companies have become Mobile Virtual Network Operators (MVNOs) to extend their brand into the wireless domain. MVNOs offer branded wireless services, such as customer management, order management, application management and/or billing management; however, MVNOs generally do not have dedicated wireless networks. Hence, MVNOs often rely on network operators to provide the underlying communication equipment capabilities to interface the MVNO systems with the communication equipment as needed.

Although MVNOs do not operate wireless networks, implementing a brand-specific wireless offering still requires a great deal of time and other resources. For example, MVNOs need to provide subscriber interfaces, third-party interfaces, and technology for customer management, order management, application management, and/or billing management. In addition, these services must be interconnected to provide a complete solution. These costs and complexities prevent many consumer brands from entering the wireless services market and becoming MVNOs.

### SUMMARY

A MVNO-enabler (MVNE) system acts as an intermediary between a brand system and a wireless network. This allows the MVNE to distribute fixed costs and administrative overhead over a greater number of wireless subscribers by aggregating the demand of multiple MVNOs.

In an embodiment, the MVNE includes a control module which receives a request for content or services from a branded company through an input interface, such as a wireless network interface, a third-party system interface or a brand system interface. The control module is adapted to communicate with a data platform services adapter which associates an external system, such as a third-party system or a data platform, with the branded company providing the request. The data platform services adapter transmits the received request to the associated external system using an output interface which adapted to communicate with the control module.

In one embodiment, the data platform services adapter includes a customer management module for customer relationship management, such as generating work orders, billing management, credit management or similar functions, which is adapted to communicate with the control module. In another embodiment, the data platform services adapter includes an order management module for controlling sales, activations, product catalog, or similar merchandising functions, which is adapated to communicate with the control module. In another embodiment, the data platform services adapter includes an application management module adapated to communicate with the control module, the application management module controlling a messaging framework or an application framework.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the following detailed description and the appended claims, when taken in conjunction with the accompanying drawings, in which:

FIG. 1 is a block diagram of an architecture for providing branded wireless services according to one embodiment of the invention.

FIG. 2 is a block diagram of a data platform services adapter according to one embodiment of the invention.

FIG. 3 is a block diagram of a MVNE system communicating with a plurality of data platforms according to one embodiment of the invention.

FIG. 4 is a flow chart of a method for providing brand-specific content or services according to one embodiment of the invention.

### DETAILED DESCRIPTION

A system and method for providing and supporting a branded wireless offering including customer-specific wireless functions is disclosed herein. For purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will be apparent from the description below. In addition, the present invention is not described with reference to any particular programming language. It will be appreciated that a variety of programming languages may be used to implement the teachings of the invention as described herein.

### System Architecture

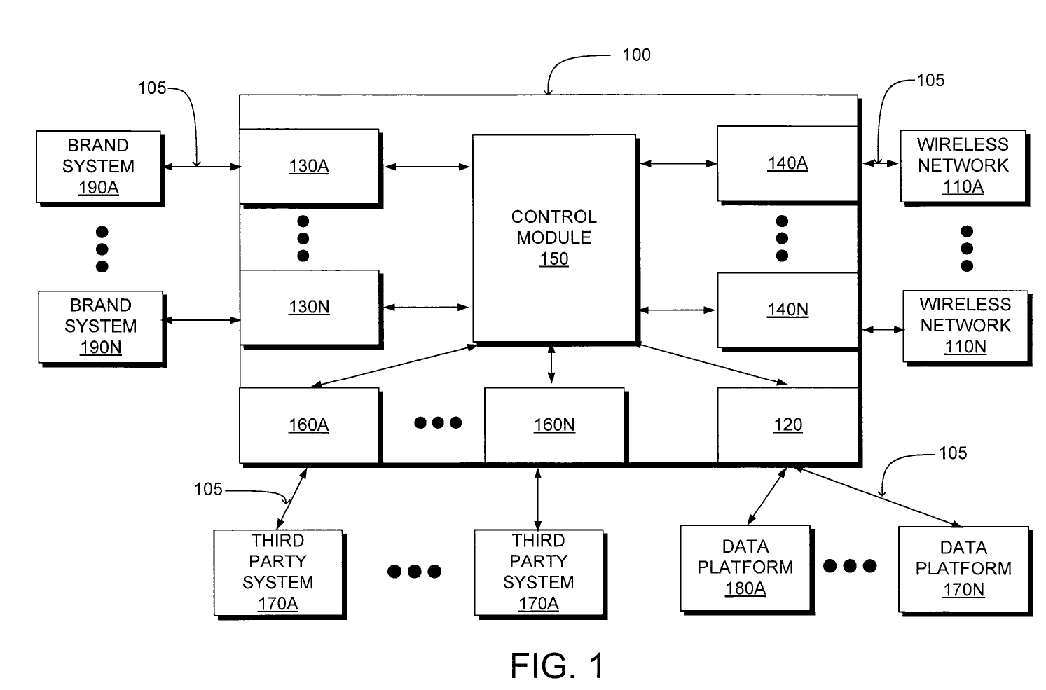

FIG. 1 illustrates a block diagram of an architecture for providing branded wireless content or services according to one embodiment of the invention. The architecture includes a Mobile Virtual Network Enabler (MVNE) system 100, one or more brand systems 190, one or more wireless networks 110, one or more third-party systems 170 and one or more data platforms 180. One or more network connections 105 allow the MVNE system 100 to communicate with the brand system 190, the third-party system 170, the data platform 180 and/or the wireless network 110. Additionally, the MVNE system uses various interfaces 130, 140, 160, further described below, to communicate data between a wireless network 110, a brand system 190, a third-party system 170 or a data platform 180 to a control module 150.

Wireless networks 110A-110N comprise networks capable of carrying mobile voice and/or data traffic, including the equipment and communication capabilities. For example, a wireless network 110 comprises wireless base stations, mobile switching centers, messaging services centers (MSCs), such as short MSCs, multimedia MSCs, or similar MSCs, home location registers (HLRs) and/or a wired line carrier. Wireless networks 110 enable services, such as, for example, provisioning, call detail record (CDR) retrieval, trouble ticketing, coverage, suspension, wireless number portability (WSP), operational support systems (OSS) integration, business support systems (BSS) integration or similar functionality. Wireless networks 110 can offer their own data platforms or could work in conjunction with one or more external data platforms 180 to request and/or retrieve data from a data platform 180 as needed. When a wireless customer of a brand system 190 uses a wireless device (not shown) to request data or initiate a voice call, the call or request and associated response are carried by one or more wireless networks 110. Hence, the wireless networks 110 allow a brand system 190 customer to use any electronic device capable of initiating and receiving wireless phone calls and/or data, such as a mobile phone, a smart phone, a personal digital assistant (PDA), a mobile communication device (e.g., a Blackberry™ or Goodlink™ e-mail device or similar device).

As shown in FIG. 1, brand systems 190A-190N comprise one or more entities, such as one or more computer systems, providing marketing, customer acquisition and branding of wireless offerings. However, brand system 190 does not include components for carrying out customer management and services associated with providing wireless services. Instead, one or more of the customer management or provider services are provided by the MVNE system 100. Hence, the MVNE system 100 connects customers of brand system 190 to one or more wireless networks 110 and provides management and/or support services for wireless voice and/or data services to one or more brand system 190 customers.

The third-party systems 170A-170N comprise application software created by one or more vendors. In one embodiment, third-party systems 170A-170N comprise proprietary application software created by various vendors. For example, third party systems 170 comprise billing or management software such as Siebel Communications™ from Siebel Systems, Inc. or Infinys™ Genefa™ software from Convergys Corporation. In one embodiment, the MVNE system 100 is adapted to communicate with multiple third-party systems 170 that offer similar or overlapping services. For purposes of illustration, FIG. 1 shows two third-party systems 170A, 170N, although any number of third-party systems 170 can communicate with the MVNE system 100.

One or more data platforms 180A-180N are adapted to communicate with the MVNE system 100. In one embodiment, a data platform 180 comprises one or more servers, each connected to one or more forms of content. In an embodiment, the one or more servers are specifically provisioned for a brand system 190 customer of an MVNE 100 and access third-party content and/or content unique to the brand system 190. For example, for a branded company offering media-themed wireless services, the brand company offers exclusive clips and programming for its users over a proprietary data server included in a data platform 180. In an embodiment, one or more data platforms 180 are provided by a third-party data system provider such as Comverse Technology Inc. or Openwave Systems, Inc. In an embodiment, when a brand company subscriber signs up for data services, modifies an existing data plan or terminates data service or other account modification, the MVNE system 100 carries out the associated transactions on the appropriate data platform 180.

In one embodiment, when a user accesses content through a data platform 180, a data request is communicated from the user's wireless device to the data platform 180 using a wireless network 110. Although a wireless network 110 can carry traffic without directly involving the MVNE system 100, in one embodiment, before providing requested content to a user, the MVNE system 100 is checked to ensure that the user is authorized to receive the content, such as by verifying that the user's service plan includes the requested action or another suitable validation technique.

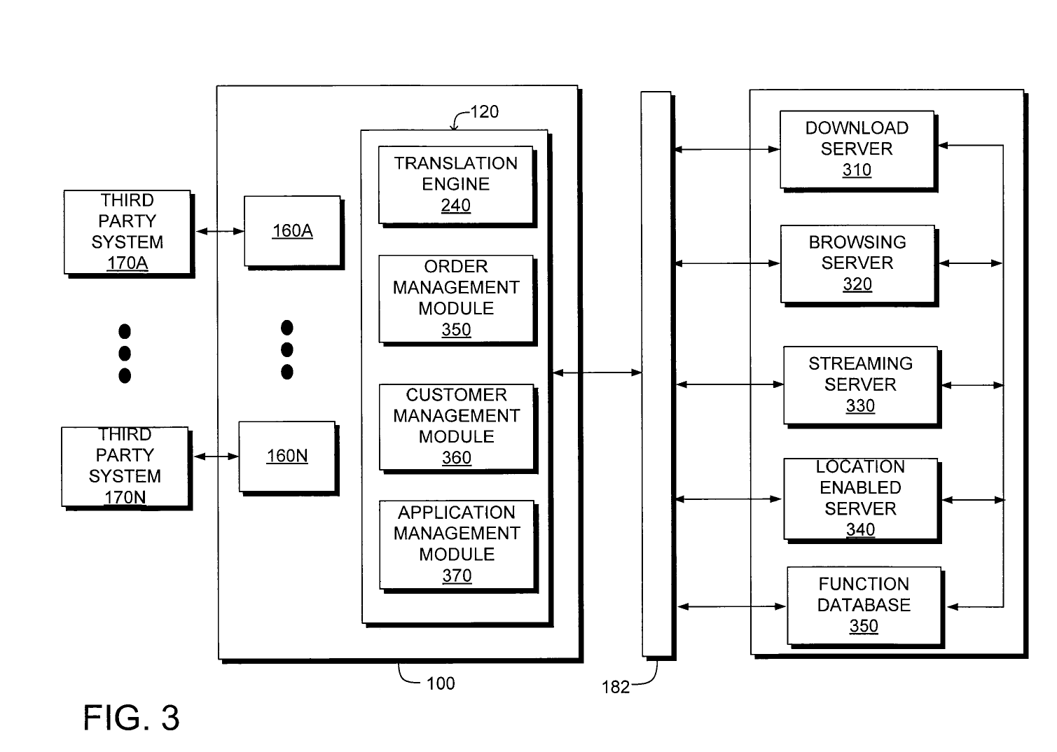

In various embodiments, the MVNE system 100 comprises a single computer or a plurality of computers adapted to communicate with each other. In one embodiment the computers comprising the MVNE system 100 comprise general-purpose computers configured to perform wireless voice and/or data management and/or support services. In an embodiment, the MVNE system 100 includes an order management module 350, a customer management module 360 or an application management module 370 allowing the MVNE system 100 to directly provide one or more management services such as customer management, order management, applications management, billing services or similar services. The order management module 350, customer management module 360 and application management module 370 are further described below in conjunction with FIG. 3. Alternatively, MVNE system 100 comprises logic for controlling or interfacing with one or more third-party systems 170 which implement management services.

In one embodiment, the MVNE system 100 includes a data platform services adapter 120, one or more brand system interfaces 130A-130N, one or more wireless network interfaces 140A-140N and one or more third-party system interfaces 160A-160N. The data platform services adapter 120 communicates with one or more data platforms 180. The brand system interface 130 allows the MVNE system 100 to communicate with one or more brand systems 190. The wireless network interface 140 allows the MVNE system 100 to interact with one or more wireless networks 110. The third-party system interface 160 enables the MVNE system 100 to interact with one or more third-party systems. For purposes of illustration, FIG. 1 shows the MVNE system 100 including two third-party system interfaces 160A, 160N, two brand system interfaces 130A, 130N and two wireless network interfaces 140A, 140N. However, in other embodiments, the MVNE system 100 includes multiple brand system interfaces 130, third-party system interfaces 160 and/or wireless network interfaces 140. The brand system interface 130, wireless network interface 140, third-party system interface 160 and/or the data platform services adapter 120 comprises a protocol for managing the data exchange between the MVNE system 100 and the brand system 190, the wireless network 110, the third-party system 170 and the data platform 180, respectively. The appropriate protocol is carried out using one or more network connections 105. The network connections 105 comprise a public network, such as the Internet, a private Local Area Network (LAN) or Wide Area Network (WAN), and can comprise a wired communication link, a wireless communication link or a combination of wired and wireless communication links.

The MVNE system 100 also includes a control module 150 which controls the MVNE system 100 and communicates with one or more third-party systems 170, one or more data platforms 180, one or more wireless networks 110 and/or one or more brand systems 190 through the third-party system interface 160, the data platform services adapter 120, the wireless network interface 140 and the brand system interface 130, respectively. The control module 150 includes a set of interconnected functions for communication with the third-party systems 170, data platforms 180, wireless networks 110 and/or brand systems 190.

In one embodiment, the control module 150 comprises multiple software processes for execution by a processor (not shown) and/or firmware applications. The software and/or firmware processes and/or applications can be configured to operate on a general purpose microprocessor or controller, a field programmable gate array (FPGA), an application specific integrated circuit (ASIC) or a combination thereof. In another embodiment, the control module 150 comprises portions or sub-routines of a software or firmware application that communicates with the data platform services adapter 120, brand system interface 130, the wireless network interface 140 and the third-party system interface 160 and/or controls MVNE system 100 actions. Moreover, other embodiments can include different and/or additional features and/or components than the ones described here.

Additionally, in various embodiments, the MVNE system 100 also includes logic for controlling front-end and/or back-end components of a wireless network 110. Front-end components may include, for example, a wireless application framework (WAF) and authentication system, a content delivery system, a messaging system, an interactive voice response unit (IVRU), a call center system, a customer relationship management (CRM) application and master customer database (DB), a product catalog system and a world-wide web/wireless application protocol (WAP) and authentication system. Examples of back-end components include a personal identification number (PIN) management system, an equipment serial number (ESN) management system, a subscriber identity module (SIM) management system, a short message service (SMS) gateway, a billing/rating and call detail record (CDR) management system, a reporting system, an enterprise resource planning (ERP) taxation system, a bill finishing and printing system, a mediation manager system, an prepaid gateway system or a prepaid service control point (SCP) system.

The MVNE system 100 supports wireless offerings of multiple brand companies using one or more wireless networks 110 and one or more data platforms 180. To support these different companies, the MVNE system 100 communicates and interacts with multiple brand systems 190, wireless networks 110, third-party systems 170 and data platforms 180, determines what brand system 190 is associated with each communication and manages traffic between the different elements. The data platform services adapter 120 handles subscriber and service transactional data relating to underlying data services. For convenience, services such as billing or provisioning services provided in support of providing data services are herein referred to as “data support services.” Additionally, services such as account maintenance, item purchasing, identity verification or similar services for establishing or maintaining a wireless account are referred to herein as “wireless functions.”

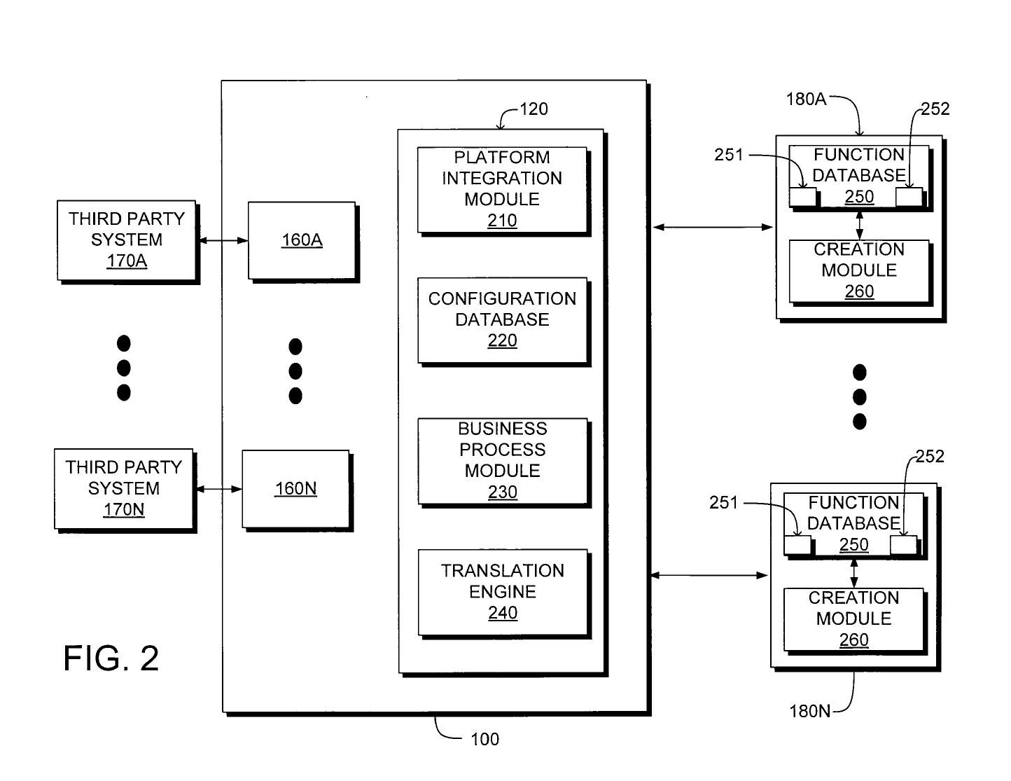

FIG. 2 is a block diagram of a data platform services adapter 120 according to one embodiment of the invention. The data platform services adapter 120 is included in the MVNE system 100 and is adapted to communicate with one or more third-party interface systems 160A-N which communicate with one or more third-party systems 170A-170N, such as CRM systems, and one or more data platforms 180A-180N. The data platforms 180 include a function database 250 describing functions associated with services or content provided by the data platform 180 and a creation module 260 adapted to communicate with the function database 250, as well as additional elements such as data servers (not shown), where provisioning and/or other requests are implemented. In one embodiment, these requests are associated with functions such as activating, supporting and/or terminating the data services of a brand company wireless customer. Information relevant to these requests is received and transmitted from a third-party system 170 to the MVNE system 100.

In one embodiment, a third-party system 170, such as a CRM system, comprises a system configured to support sales, provisioning, billing, marketing or other customer-service transaction, and store data associated with the transaction. Data associated with service activation, support and/or termination is communicated between a third-party system 170, such as a CRM system, and the MVNE system 100. In one embodiment, the MVNE system 100 uses the third-party interface 160 to communicate with the third-party system 170. Commonly, the third-party system 170 is implemented using a combination of hardware and software. For example, general purpose computer hardware running multiple software processes is used to implement the third-party system 170 as a software process. Alternatively, the third-party system 170 is implemented using multiple software processes running on a plurality of separate computer systems as a distributed computer system.

The data platform services adapter 120 includes a platform integration module 210, a configuration database 220, a business process module 230 and a translation engine 240. However, in other embodiments, the data platform services adapter 120 includes different and/or additional features and/or components than the ones described here.

The business process module 230 comprises logic for handling data support service requests and for determining actions to be taken by the data platform services adapter 120 to implement the requests. The requests originate from a variety of sources, such as the third-party system 170, such as a CRM system, a billing system, a retail system, a consumer system or another system capable of receiving and/or transmitting service requests. In an embodiment, data and requests within the MVNE system 100 are represented in various independent formats. Alternatively, data and requests are represented in a canonical data format including objects relevant to the request, such as customer identifier, customer contract, customer contact data, customer plan, data request or other data associated with the customer and/or data request. Objects in the canonical data form are associated with additional network data, such as network entity, customer entity, subscriber entity, plan entity or other data associated with the network configuration. The business process module 230 then maps the received request into one or more operational tasks for implementing the request. For example, if the business process module 230 receives a request to allocate data services to a customer, the business process module 230 requests information about the customer, provides customer information to a third-party system 170, determines the data platform 180 affected or specified by the request and interacts with additional elements necessary to carry out the request. As the data platform services adapter 120 processes requests from multiple brand systems 190, when a request is received, the business process module 230 determines the third-party system 170, the data platform 180 or the other platform elements utilized and how to interact with the systems, platforms or other elements.

The configuration database 220 comprises associations between brand systems 190 and third-party vendors or data platforms 180 selected by the brand system 190. The configuration database 220 receives requests from the business process module 230, and communicates the association corresponding to the received request back to the business process module 230. The configuration database 220 also includes the communication requirements and/or protocols associated with the third-party vendors or data platforms 180. Alternatively, communication requirements and/or protocols needed to implement a request are stored in association with additional characteristics of an incoming request, such as the selected service tier or the customer wireless network.

In one embodiment, the configuration database 220 comprises a hard disk drive, a flash memory device or other suitable mass storage device. In another embodiment, the configuration database 220 comprises a volatile storage device (e.g., dynamic random access memory (DRAM), static random access memory (SRAM) or another suitable memory device), a non-volatile storage device or a combination of a non-volatile storage device and a volatile storage device.

When a request is received by the business process module 230, the business process module 230 identifies a brand system 190 associated with the received request and then retrieves corresponding platform, system and format specifications from the configuration database 220. For example, data stored in the configuration database 220 specifies that when a request is received from brand company B, a data provisioning request is sent to data platform C, specifically to data platform elements server D and server E. Data stored in the configuration database 220 also provides that calls to server D are made using any commonly deployed industry protocol, such as extensible markup language (XML) over secure hypertext transfer protocol (HTTPS) or a Common Object Request Broker Architecture (CORBA) and calls to server E are made using a Wireless Access Protocol (WAP). Alternatively, when the business process module 230 receives a request and identifies the brand system 190 associated with the request, the business process module 230 communicates the request to an order management module 350, a customer management module 360 or an application management module 370 included in the data platform services adapter 120. In this configuration, the data platform services adapter 120 allows the MVNE system 100 to locally perform one or more wireless functions or provide one or more data services.

The business process module 230 further communicates a request to the translation engine 240 including the tasks and communication requirements retrieved from the configuration database 220. The translation engine 240 then generates calls in the appropriate format for the appropriate destination, such as a third-party system 170 or a data platform 180, using the received request. For example, the translation engine 240 creates a call using data transformation, protocol information and application protocol interface (API) information retrieved from the configuration database 220. In one embodiment, the translation engine 240 also executes the calls to external systems such as the third-party system 170 or data platform 180. As the translation engine 240 handles multiple calls on behalf of various brand systems, different calls are identified by unique transaction identifiers so that traffic to and from the translation engine 240 is routed to the appropriate destination.

In one embodiment, the translation engine 240 includes data describing a plurality of functions, such as application programming interface (API) information. In one embodiment, the data describing the plurality of functions comprises data identifying one or more inputs, such as data describing input type, data describing input format or other data describing how a function receives input. In another embodiment, the data describing the plurality of functions also includes data identifying one or more outputs, such as data describing output format, data describing output type or other data describing characteristics of a function output. For example, the translation engine 240 includes extensible markup language (XML) data describing input data, output data and how to execute the plurality of functions, such as an XML schema associated with different functions. In one embodiment, the stored API information comprises XML schemas for different functions, such as subscription activation, identify verification, check or credit card charging or other functions used in wireless communication systems. The stored XML schemas include a plurality of components, where a subset of the components are required for execution of the function and a second subset of the components are optional and are included or excluded as specified by various branded companies.

Additionally, the translation engine 240 also includes data associating one or more functions, services or content with a brand system 190, allowing retrieval of data describing a plurality of functions, content or services associated with a brand system 190. This allows different brand systems 190 to differently execute functions, provide content or implement services based on data associated with the brand system. This allows different brand systems 190 to provide customized functions, content or services while also using common resources to execute the functions.

Because the data platform services adapter 120 interacts with a plurality of data platforms 180, when a brand company or MVNO chooses one or more data platforms 180 or third-party systems 170 the platform integration module 210 establishes the brand or MVNO customer with the corresponding data platform 180 or third-party system 170 selection. When connections between the data platform services adapter 120 are already established, an instance of the brand company customer or MVNO customer is configured on the data platform 180 or third-party system 170. For example, when a brand company is established, the platform integration module 210 associates a unique identifier with the brand company and communicates the unique identifier to the data platform 180 or third-party system 170. The unique identifier specifies data platform 180 or third-party system 170 transactions associated with brand company customers. This identification method leverages pre-existing connections between the data platform services adapter 120 and the data platform 180 or third-party system 170 to provide customized data offerings for the brand company. Moreover, this design allows for the brand company to offer data services and products that leverage data services independent of the wireless network 110 and without dependency on data platforms deployed by the wireless network 110. Additionally, this configuration allows a brand company to use a local data platform 180, multiple data platforms 180 or communicate with third parties to access data platforms 180.

A different protocol is then used to introduce a new data platform 180 or new third-party system 170 to the MVNE system 100. Data, such as program code, specific to the data platform 180 or third-party system 170 is created to allow the MVNE system 100 to communicate with the new data platform 180 or new third-party system 170. The data platform 180 or third-party system 170 specific data specifies data platform 180 or third-party system 170 protocol and communication requirements. Relevant data is communicated to the configuration database 220 (e.g., the brand company's data platform selections) and the translation engine 240 (e.g., new protocols, new data transformations and API data for connecting to the new data platform 180 or new third-party system 170).

Further, to allow multiple brand companies to customize function implementations, various data platforms 180 or third-party systems 170 include a function database 250. In one embodiment, the function database 250 includes a standardized interface module 251 which includes required components and a plurality of optional components. The standardized interface module 251 describes how the data platform 180 or third-party system 170 implements different functions and allows platform-specific function customization. The creation module 260 is adapted to communicate with the function database 250 and communicates data or instructions to the function database 250 describing modifications to the interface module. Hence, the local function database 250 and creation module 260 allow different data platforms 180 to differently implement functions. This customized implementation allows brand systems 190 to share resources while still providing customized services to subscribers or customers. Modifying the optional components of the standardized interface module 251 allows multiple brand systems 190 to use resources configured to execute the standardized interface module 251 while also varying the required and/or generated data according to specialized brand system 190 criteria.

For example, the creation module 260 specifies which optional components from the standardized interface module 251 are used to implement a function described by the standardized interface module 251, creating a brand-specific interface 252. Specifying one or more optional components allows the creation module 260 to vary the input and/or output parameters to a function, altering the input requested and/or the output produced according to different requirements. The brand-specific interface 252 is then stored. In one embodiment, the brand-specific interface 252 is included in the function database 250. Alternatively, the brand-specific interface 252 is stored in a separate storage device included in the data platform 180. In another embodiment, the brand-specific interface 252 is communicated to MVNE system 100 and stored in the configuration database 220 or the translation engine 240.

The MVNE system 100 is then notified of the generated brand-specific interface 252 (e.g., by receiving a notification message, by receiving a copy of the brand-specific interface 252 or another suitable notification method). The MVNE system 100 then modifies the translation engine 240 to associate the brand-specific interface 252 with the data platform 180 which created the brand-specific interface 252. For example, a data platform 180 identifier or third-party system 170 identifier is associated with the brand-specific interface 252 and the association is then stored in the translation engine 240 This allows brand companies to customize function execution, while still allowing centralized function execution control by the MVNE system 100.

For example, the MVNE system 100 communicates a standardized interface module 251 describing a plurality of functions to multiple data platforms 180. The data platforms 180 or third-party systems 170 initially store the standardized interface module 251 in the local function database 250. The creation modules 260 on multiple data platforms 180 or third-party systems 170 then modify the locally stored standardized interface module 251 to generate a brand-specific interface 252 describing how the data platform executes one or more functions. For example, the creation module 260 selects optional components from the standardized interface module 251 identifying specific input variables to request when executing a function, or removes specific output variables to prevent presentation of certain data. The brand-specific interface 252, or data describing the brand-specific interface 252, is then communicated to the MVNE system 100. The MVNE system 100 then modifies the translation engine 240 to associate the brand-specific interface 252 with the data platform 180 which generated the brand-specific interface 252.

FIG. 3 is a block diagram of an MVNE system 100 communicating with a data platform 180 according to one embodiment of the invention. The MVNE system 100 includes a data platform services adapter 120 which interfaces with multiple elements of the data platform 180 to activate, support or terminate the data services of a brand company customer. In one embodiment, the data platform services adapter 120 communicates with a download server, browsing server 320, a streaming server, a location enabled server 340 and a function database 250 included in the data platform 180. For purposes of illustration, FIG. 3 illustrates an MVNE system 100 communicating with a data platform 180; however, in other embodiments, a similar architecture is used for communication between an MVNE system 100 and a third-party system 170.

Hence, the data platform services adapter 120 allows the MVNE system 100 to offer an MVNO a choice of services, such as different wireless carriers, different billing providers and/or different content providers. This allows the MVNO to provide customized product and service offerings and to modify or change different aspects, such as content provider or billing provider, of a branded wireless offering.

In one embodiment, a data administration layer 182 is also included to facilitate communication between the data platform services adapter 120 and data platform 180 elements. For purposes of illustration, the data administration layer 182 is shown in FIG. 3 as a discrete module. However, in alternative embodiments, the data administration layer 182 is included in the data platform 180 or the MVNE system 100.

The data administration layer 182 comprises an interface layer handling authentication and session management in transactions of the data platform 180 and mediates transactions between the data platform services adapter 120 and the download server 310, browsing server 320, streaming server 330, location enabled server 340 and/or function database 250. The data administration layer 182 also controls security and access control to the download server 310, browsing server 320, streaming server 330, location enabled server 340 and/or function database 250. In one embodiment, the data administration layer 182 also determines which classes of services a user can access. In one embodiment, the data administration layer 182 comprises an authentication, authorization and accounting (AAA) layer. In various embodiments, additional layers are also included, such as layers providing services, applications or content (e.g., a mapping server, a game server or similar server).

In one embodiment, content is locally served from one of the download server 310, browsing server 320, streaming server 330 or location enabled server 340. For example, brand companies customize their customers' experiences by, for example, devising specific interfaces, menus and/or portals for their customers. The download server 310 stores static content, for example, ringtones, wallpaper or video clips. In one embodiment, the download server 310 is refreshed on a regular basis.

The browsing server 320 provides subscribers with the ability to browse internet uniform resource indicators (URIs). The browsing server 320 forwards a hypertext transfer protocol (HTTP) request entered in a wireless device to the Internet, retrieves the requested URI and returns the URI to the wireless device. In one embodiment, the data platform 180 also includes a messaging server (not shown) allowing users to engage in text messaging, voice messaging, ring-tone delivery, intra-private-label, brand customer messaging, inter-carrier messaging or similar messaging-type services.

The streaming server 330 provides streaming content to one or more wireless devices responsive to receiving a request for streaming content, such as a live video or audio feed. The streaming server 330 communicates with a content source such as a video feed or music feed from a satellite or internet radio source, or other streaming data source. The streaming server 330 also filters, transcodes and streams the requested data to the requesting wireless device, or devices.

In one embodiment, the data platform 180 also includes a location enabled server 340 that determines a user's location and provides data responsive to the user's location. For example, the location enabled server 340 determines a user's location and provides the user with data regarding restaurants, transportation schedules, stores or other data near the user's location.

The function database 250 includes data describing how the data platform 180 implements one or more wireless communication functions, such as the standardized interface module 251 and/or the brand-specific interface 252. For example, the function database 250 includes the brand-specific interface 252 which describes how a brand company implements a user authentication or payment processing function. Hence, the function database 250 allows different data platforms 180 to differently implement functions, such as by requesting different input or generating different output when a function is implemented by different data platform 180. This customization allows branded companies to implement functions in a company-specific manner using a centralized MVNO architecture.

In one embodiment, one or more of the download server 310, browsing server 320, streaming server 330, location enabled server 340 and/or function database 250 provides requested content using a protocol determined by one or more characteristics of the content, requesting wireless device and/or the wireless network. One or more of the download server 310, browsing server 320, streaming server 330, location enabled server 340 and/or function database 250 provides the requested data via a wireless access protocol (WAP), multimedia message service (MMS), file transfer protocol (FTP), real time streaming protocol (RTSP) or other similar data communication format.

When a customer initiates, changes or terminates a data service, the data platform services adapter 120 communicates data to the appropriate data platform 180 elements and the third-party system 170. For example, to activate a customer, information about the customer is passed to the data platform 180 in the format corresponding to the data platform 180. In one embodiment, this information comprises one or more of the customer's electronic serial number (ESN), mobile directory or dialing number (MDN) or mobile subscriber ID (MSID), as well as data plans and features selected by the customer. For example, a customer elects a package of basic or premium data services, a class of service or selects options related text messaging, e-mail, Internet browsing or streaming content downloading.

Information communicated to the data platform 180 or third-party system 170 is received by the data administration layer 182, which stores a subset of the communicated data in a customer profile. Messages regarding the options or features selected by the customer are provided to one or more of the download server 310, browsing server 320, streaming server 330, location enabled server 340 or function database 250. For example, if the customer selects a plan allowing for streaming video content, a message requesting allocation of streaming server 330 resources to the customer is transmitted to the data platform 180. Once activation is completed at the data platform 180, the data administration layer 182 sends a message to the data platform services adapter 120 that activation was successfully completed and this confirmation data is then sent to a third-party system 170.

In one embodiment, the data platform services adapter 120 includes an order management module 350, a customer management module 360 and an application management module 370. These modules allow the data platform services adapter 120 to perform one or more transactions or functions to support data services. The order management module 350 controls sales, activations, product catalogs and product campaigns. The customer management module 360 controls customer relationship management, such as work orders, service orders, trouble tickets, premises management, loyalty and retention services, credit management, fraud management and/or contract management. The application management module 370 controls a messaging framework and an application framework, such as email, SMS, MMS or other data sent to and from users and/or systems.

For example, the customer management module 360 implements customer maintenance transactions to change or update plan or customer information or query characteristics of a customer's existing data choices or preferences. When a customer attempts to change customer information, a request for details about the existing plan stored in the data administration layer 182 is transmitted from the customer management module 360 using the data platform services adapter 120 to a data platform 180. In one embodiment, the customer management module 360 evaluates whether the change requested is compatible with the existing plan. For example, if the existing plan is a service allowing for unlimited downloads, a request to add additional downloads is declined because the plan already includes this feature.

As another example, if a customer changes their wireless device, the customer management module 360 receives the ESN of the new wireless device from the wireless device then transmits the received ESN to the data platform 180. Or if a customer phone number is changed, an updated MDN and/or MSID is received by the customer management module 360 which communicates the revised data to the data platform 180. Alternatively, responsive to a customer request or a customer's failure to pay a bill or termination of a contract, a request to terminate service is received by the customer management module 360 and then communicated to the data platform 180.

Hence, the data platform services adapter 120 allows the MVNE system 100 to receive a request from a customer wireless device and communicate the request, or data associated with the request, to a data platform 180 and/or a third-party system 170 to retrieve content or to provide a service associated with the request. Alternatively, the data platform services adapter allows the MVNE system 100 to locally provide one or more services associated with a received request through the order management module 350, the customer management module 360 and/or the application management module 370.

### System Operation

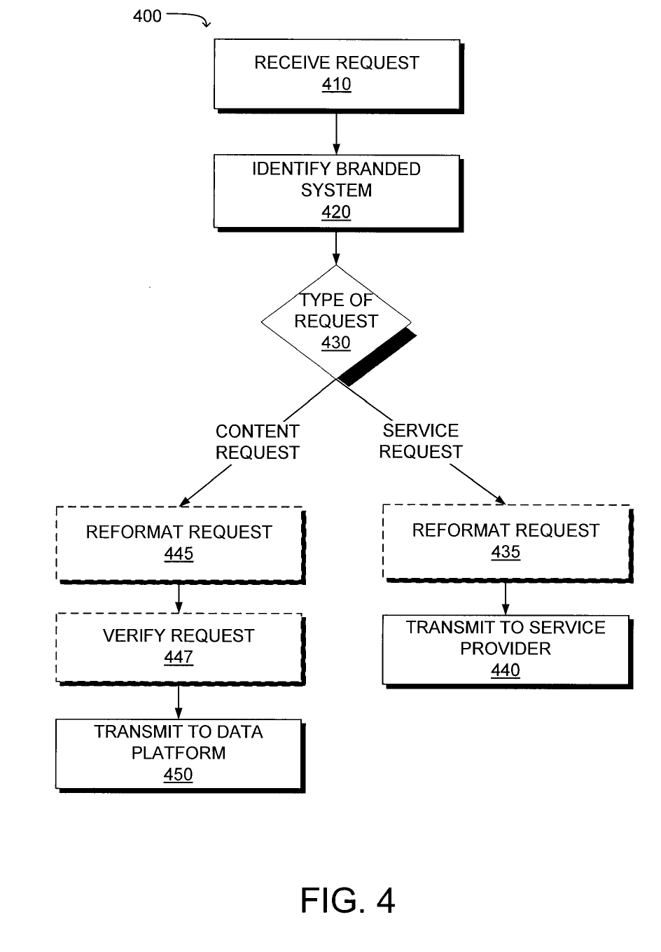

FIG. 4 is a flow chart of a method 400 for providing brand-specific content or services using distributed resources according to one embodiment of the invention. In an embodiment, the steps of the method 400 are implemented by a microprocessor (not shown) executing software instructions that cause the described actions. Those of skill in the art will recognize that the method may be implemented in embodiments of hardware and/or software or combinations thereof. For example, instructions for performing the described actions are embodied or stored within a computer readable medium. Furthermore, those of skill in the art will recognize that other embodiments can perform the steps of FIG. 4 in different orders. Moreover, other embodiments can include different and/or additional steps than the ones described here.

Initially, the control module 150 of the MVNE system 100 receives 410 a request for content or a request to perform a service from a customer of a brand system 190 via a network connection 105. For example, the received request comprises a request for content, such as video, graphical or text data, a request for a location enabled service or other request for data or information from a data platform 180 or other data source. Alternatively, the received request comprises a request to perform a service, such as changing a data plan, updating an ESN associated with a wireless device, paying a bill, terminating a service or other action which modifies one or more services available to a customer or other user. In one embodiment, a service provider, such as a third-party system 170 or an order management module 350, a customer management module 360 or an application management module 370, performs the requested service.

The control module 150 then communicates the received request to the data platform services adapter 120. The business process module 230 included in the data platform services adapter 120 then identifies 420 the brand system 190 associated with the received request and classifies 430 the request as a request for content or a request for a service. If the request is classified 430 as a request for a service, the request is transmitted 440 to a service provider, such as a third-party system 170 or a local order management module 350, customer management module 360 or application management module 370. In one embodiment, the request is reformatted 435 into a format used by the service provider prior to transmission to the service provider to reduce the time necessary to provide the requested service.

If the request is classified 430 as a request for content, the request is transmitted 450 to a data platform 180 based on data in the configuration database 220. The content request is transmitted 450 to the data platform 180 associated with the brand system 190 where the request originated. In one embodiment, the content request is reformatted 445 into a format used by the data platform 180 to simplify identification and/or retrieval of the requested content. In another embodiment, prior to transmitting 450 the content request, the content request is also verified 447 to determine whether the requested content is permitted under a service plan. For example, if providing the requested content would exceed a number of downloads specified in the service plan, the content request is declined rather than transmitted 450. Verification allows the MVNE system 100, rather than the brand system 190, to determine whether or not content requests are permitted. In an embodiment, the MVNE system 100 locally verifies 447 the content request using the customer management module 360 or the order management module 350. Alternatively, the MVNE system 100 transmits a verification message to a third-party system 170 to verify 447 the content request.

If the content request is verified 447, the MVNE system 100 receives the content from the data platform 180. In one embodiment, the received content comprises data such as a web page, a multimedia file or a text file and an identifier specifying the brand system 190, associated with received request. The MVNE system 100 then transmits the received content to the identified brand system 190 for communication to the requesting customer.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Of course, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. An apparatus for providing content or services customized to a branded company comprising:
a control module adapted to communicate with an input interface and an output interface, the control module receiving a request from the branded company through the input interface; and
a data platform services adapter adapated to communicate with the control module, the data platform services adapter associating an external system with the branded company, transmitting the request from the branded company to the external system through the control module and transmitting data received from the external system to the branded company via the output interface independent of a wireless data infrastructure of a wireless network provider associated with the branded company.

2. The apparatus of claim 1, wherein the data platform services adapter further modifies the received data into a format associated with the external system.

3. The apparatus of claim 1, wherein the external system comprises a third-party system or a data platform.

4. The apparatus of claim 1, wherein the data platform services adapter includes a customer management module, the customer management module performing at least one of work order assignment, service order receipt, promotional offer generation, promotional offer transmission or account billing responsive to the received request.

5. The apparatus of claim 1, wherein the data platform services adapter includes an order management module, the order management module performing at least one of updating a product catalog, selecting a product campaign or activating a wireless device.

6. The apparatus of claim 1, wherein the data platform services adapter includes an application management module, the application management module modifying a messaging framework describing transmission of data between the external system and the data platform services adapter.

7. The apparatus of claim 1, wherein the data platform services adapter further classifies the request as a service request or a content request.

8. The apparatus of claim 7, wherein responsive to classifying the request as the service request, the data platform services adapter further transmits the service request to a third-party system.

9. The system of claim 7, wherein responsive to classifying the received request as the content request, the data platform services adapter further transmits the content request to a data platform.

10. The system of claim 9, wherein responsive to classifying the request as a content request, the data platform services adapter generates a verification request associated with the content request and determines if the content request is permitted based on a service plan.

11. A method for providing content or services customized to a branded company comprising:
receiving a request;
identifying the branded company associated with the received request;
determining a type associated with the received request;
responsive to determining the type associated with the received request is a content request, transmitting the received request to a data platform associated with the branded company; and
responsive to determining the type associated with the received request is a service request, transmitting the received request to a service provider associated with the branded company.

12. The method of claim 11, wherein the service provider comprises a third-party system associated with the branded company.

13. The method of claim 11, wherein the service provider comprises an order management module, a customer management module or an application management module.

14. The method of claim 11 wherein transmitting the received request to the data platform associated with the branded company comprises:
reformatting the received request into a format associated with the data platform associated with the branded company to generate a reformatted request; and
transmitting the reformatted request to the data platform associated with the branded company.

15. The method of claim 11, wherein transmitting the received request to a service provider associated with the branded company comprises:
reformatting the received request into a format associated with the service provider associated with the branded company to generate a reformatted request; and
transmitting the reformatted request to the data platform associated with the branded company.

16. The method of claim 11 wherein transmitting the received request to the data platform associated with the branded company comprises:
generating a verification message associated with the received request;
transmitting the verification message to the service provider associated with the branded company; and
receiving a confirmation from the service provider associated with the branded company; and
responsive to receiving the confirmation, transmitting the received request to the data platform associated with the branded company.

17. A computer program product for implementing for providing content or services customized to a branded company comprising, the computer program product comprising a computer-readable medium including computer program code for performing a method comprising:
receiving a request;
identifying the branded company associated with the received request;
determining a type associated with the received request;
responsive to determining the type associated with the received request is a content request, transmitting the received request to a data platform associated with the branded company; and
responsive to determining the type associated with the received request is a service request, transmitting the received request to a service provider associated with the branded company.

18. The computer program product of claim 17, wherein the service provider comprises a third-party system associated with the branded company.

19. The computer program product of claim 17, wherein the service provider comprises an order management module, a customer management module or an application management module.

20. The computer program product of claim 17, wherein transmitting the received request to the data platform associated with the branded company comprises:
reformatting the received request into a format associated with the data platform associated with the branded company to generate a reformatted request; and
transmitting the reformatted request to the data platform associated with the branded company.

21. The computer program product of claim 17, wherein transmitting the received request to a service provider associated with the branded company comprises:
reformatting the received request into a format associated with the service provider associated with the branded company to generate a reformatted request; and
transmitting the reformatted request to the data platform associated with the branded company.

22. The computer program product of claim 17, wherein transmitting the received request to the data platform associated with the branded company comprises:
generating a verification message associated with the received request;
transmitting the verification message to the service provider associated with the branded company; and
receiving a confirmation from the service provider associated with the branded company; and
responsive to receiving the confirmation, transmitting the received request to the data platform associated with the branded company.
